(19) United States
(12) Patent Application Publication
(10) Pub. No.: US 2007/0113533 A1
(43) Pub. Date: May 24, 2007

(54) Feeding device for a field chopper

(76) Inventors: Rainer Schafer, Zweibrucken (DE); Matthew George Dold, Mandelbachtal (DE)

Correspondence Address: DEERE & COMPANY, ONE JOHN DEERE PLACE, MOLINE, IL, 61265, US

(21) Appl. No.: 11/525,299

(22) Filed: Sep. 22, 2006

(30) Foreign Application Priority Data
Nov. 24, 2005 (DE) 10 2005 055 983.2

(51) Int. Cl. A01D 61/00

(52) U.S. Cl. 56/16.4 R

(57) ABSTRACT

The invention relates to a feeding device (32) for a field chopper (10), comprising:

at least one rotatable lower feedroll (34, 35),

at least one rotatable upper feedroll (36, 37), between which a windrow can be fed and led to a chopping device (22),

and an external force-activated adjustment drive (68), with which the position of at least one of the feedrolls (36, 37) can be changed relative to the other feedroll (34, 35).

It is proposed that a spring (58) be arranged between the adjustment drive (68) and the feedroll (36, 37) that can be moved by this drive.

The spring (58) enables the movable feedroll (36, 37) to react more quickly or immediately to sudden changes in windrow height independent of the inertia of the adjustment drive (68).

### FIELD OF THE INVENTION

The invention relates to a feeding device for a field chopper, comprising at least one rotatable lower feedroll, at least one rotatable upper feedroll, between which a windrow can be fed and led to a chopping device, and an external force-activated adjustment drive, with which the position of at least one of the feedrolls can be changed relative to the other feedroll.

### BACKGROUND OF THE INVENTION

Field choppers are used in agriculture in order to cut or collect crop from a field by means of a crop pick-up device, to feed crop to a chopping device, usually a chopping drum or a slice chopper, via a feeding device, in order to chop the crop and to eject it onto a transport vehicle, usually after being accelerated by means of a blower, through an ejection elbow whose position is adjustable. In most cases, the harvested plants are used as silage for feeding animals or, in recent times, for biogas production.

In currently used field choppers (see DE 102 10 437 C), the feeding device comprises two lower feedrolls mounted rigidly on the frame of the field chopper and two upper feedrolls interacting with these lower rolls. The upper feedrolls are mounted to be movable in height against the force of one or more springs, in order to be able to yield upwards when the crop is picked up. The spring has the task of applying a defined force onto the upper feedrolls, so that the rolls interacting with the lower feedrolls can, on the one hand, roughly compact the crop during pick-up and, on the other hand, with the aid of this roller force, make possible for the first time the pick-up of the crop and its transport to the chopping drum.

Due to the characteristics of the mechanical springs, essentially a linear dependency is produced between the feedroll force and the windrow height. Smaller windrow heights, as produced especially when loading and unloading from the crop stock, lead to a relatively low feedroll force. Consequently, this leads to undesired overlengths in the chopping material, because the chopping blades pull out plants or plant parts from the windrow not adequately held between the two backward feedrolls and can be transferred uncut into the ejected crop stream. Such overlengths are undesired, especially for biogas production. The pre-tensioning of the springs could definitely be increased, which, however, would lead to premature material fatigue of the springs and extremely high contact pressure for larger windrow heights.

EP 0 519 209 A proposes connecting a damping element constructed as a hydraulic shock absorber to the feedrolls pre-tensioned downwards by the spring force for preventing natural oscillation states in the upper feedrolls. This shock absorber cannot solve the above problem of overlengths produced for low windrow heights.

It has been further proposed to generate the contact pressure of the feedrolls hydraulically. In a brochure “Model 7730 Self-Propelled Forage Harvester,” reference FQ-1-184 of Hesston Corporation, Hesston, Kans., USA, a field chopper with a hydraulic cylinder for generating the feedroll pressure is described. The hydraulic cylinder is connected to an accumulator, which supplies the cylinder with a constant pressure. Here, the contact pressure of the feedrolls does remain constant (as long as the windrow height does not change abruptly) but the inertia of the hydraulic cylinder does not allow the feedrolls to react quickly enough for rapidly changing windrow heights, so that here, undesired overlengths are also possible for quickly decreasing windrow heights. For quickly increasing windrow heights, relatively high binding forces are applied, which lead to high mechanical loads on the feedrolls. This solution has not gained acceptance in practice.

DE 195 39 143 A likewise proposes a hydraulic generation of the contact pressure of the upper feedrolls. The double-acting hydraulic cylinder is connected to a valve device, which is connected, in turn, to a controller. The controller adjusts the pressure in the hydraulic cylinder to a desired pressure value by controlling the valve device based on measurement values from sensors detecting the operating pressure in the hydraulic cylinder. The desired pressure value can be determined by an automatic machine controlled as a function of the load and/or crop. Here, the pressure in the hydraulic cylinder and thus the contact force of the upper feedrolls can definitely be controlled by the load on the field chopper, but the disadvantages due to the inertia of the hydraulic cylinder, which were mentioned in terms of the field chopper by Hesston, are also present here.

### SUMMARY OF THE INVENTION

The problem forming the basis of the invention is to provide a feeding device for a field chopper, in which an adequate feedroll force is achieved also for smaller windrow heights and which enables a quick adaptation of the position of the feedrolls for sudden changes in windrow height.

This problem is solved according to the invention by the teaching of Claim 1, wherein in the other claims, features are listed, which improve the solution in advantageous ways.

A feeding device of a field chopper comprises at least one lower and one upper feedroll. One of the feedrolls can be moved against the other feedroll by means of an external force-activated adjustment drive. It is proposed to arrange a mechanical spring, which preferably pre-tensions the feedroll that can be moved by the adjustment drive against the other feedroll, between the moving gate of the adjustment drive and the feedroll that can be moved by this drive.

In this way, through suitable control of the adjustment drive, a contact pressure, which is at least approximately independent of the position of the movable feedroll and thus the crop throughput or arbitrarily dependent on the crop throughput, is generated on the movable feedroll. The spring enables the movable feedroll, independently of the inertia of the adjustment drive, to react more quickly or immediately to sudden changes in windrow height. Therefore, also for small windrow height, a sufficient contact pressure can be achieved, which helps to prevent undesired overlengths in the chopping material.

As the spring, preferably a tension spring is used i.e., a spring whose effective force increases with elongation. Therefore, the spring can be arranged in a compact way laterally next to the feeding device. For other embodiments, however, a compression spring can also be used, which can be mounted above or below the movable feedroll.

A compact construction of the feeding device is achieved by connecting a first end of the spring to the feedroll and a second end of the spring to an oscillating and/or movable first holder, which is further connected to the moving gate of the adjustment drive. Through this arrangement, it becomes possible to arrange the spring and the adjustment drive next to each other, especially to orient them at least approximately parallel to each other and/or vertical, especially laterally next to the feeding device.

Because usually two (or more) upper feedrolls are arranged to be movable, while two (or more) lower feedrolls are fixed rigidly on the frame of the field chopper, an obvious solution is to attach the upper feedrolls in common to a rocker, which is also connected to the spring, which extends downwards from the rocker. The moving gate of the adjustment drive can be closed at the described holder and can be arranged next to the spring, i.e., laterally next to or ahead of or behind the spring in the forward direction.

In a known way, a hydraulic cylinder or hydraulic motor can be used as the adjustment drive. The use of an electric motor or a pneumatic cylinder is also conceivable.

The adjustment drive can be designed to generate a constant—i.e., independent of the position of the feedroller—contact pressure of the feedroller, which can be realized, for example, by connecting a hydraulic cylinder acting as an adjustment drive to an accumulator, which provides a hydraulic fluid under a given or variable pressure (controllable by an operator or arbitrary sensors detecting, e.g., the type of crop) for applying pressure to the hydraulic cylinder. In another embodiment, a controller is connected to the adjustment drive and to a crop throughput sensor designed for detecting the crop throughput (e.g., the windrow height), which triggers the adjustment drive to move based on the output of the crop throughput sensor, such that the contact pressure of the feedrolls on the crop remains at least approximately independent of the crop throughput or increases with increasing throughput according to an arbitrary, suitable characteristic line. The throughput gap between the feedrolls is consequently increased with increasing windrow height and decreases with decreasing windrow height.

The current throughput can be detected by means of a crop throughput sensor designed for detecting the position of a moving feedroll. However, another arbitrary crop throughput sensor suitable for detecting the crop throughput can also be used, which, e.g., detects the load on the chopping device or the blower or the crop header or determines the height of the windrow optically or mechanically.

As already mentioned, the controller can control the adjustment drive such that a desired contact pressure of the feedrolls is achieved. For regulation purposes, it would be possible to detect the pressure in a hydraulic cylinder acting as the adjustment drive and to feed corresponding information to the controller. In this case, the controller would regulate the pressure in the hydraulic cylinder to the desired value. In another embodiment, a spring-position sensor is used, in order to detect the elongation of the spring, which is a measure of the force exerted by the spring on the feedroll and of the contact pressure of the feedroll. The signal from the spring-position sensor is used to control the regulating input parameter for adjusting the position of the adjustment drive. For this purpose, a slide or rotary potentiometer moved by the spring can be used, which is connected to each end of the spring. In another embodiment, separate sensors are provided for detecting the position of the movable feedroll and the adjustment drive. The difference of the signals of the sensors contains information on the elongation of the spring, which is likewise used by the controller as a regulating input parameter for adjusting the position of the adjustment drive.

### DESCRIPTION OF THE PREFERRED EMBODIMENT

The drawings illustrate an embodiment example of the invention described in more detail below. Shown are:

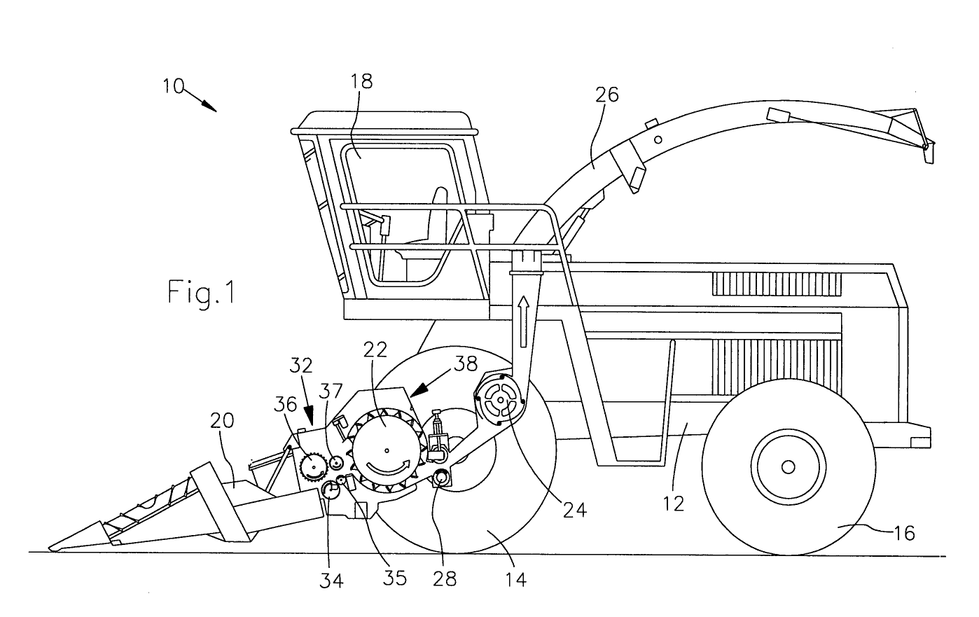

FIG. 1, a field chopper with a feeding device in a side view and in a schematic representation, and

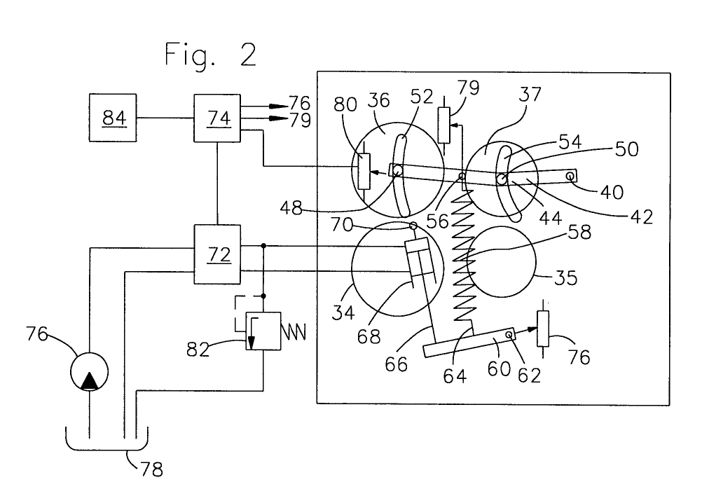

FIG. 2, a schematic side view of the feeding device and its control.

A self-propelled field chopper 10 shown in FIG. 1 is built on a frame 12, which is carried by wheels 14 and 16, which have front-wheel drive and rear-wheel steering. The operation of the field chopper 10 is performed from a driver cabin 18, from which a crop pick-up device 20 constructed in the present embodiment as a corn-harvesting header can be seen. Material, e.g., corn, grass, or the like, picked up from the ground by means of the crop pick-up device 20 is fed by a feeding device 32 arranged in a feed channel of the field chopper 10 with lower feedrolls 34, 35 and upper feedrolls 36, 37 to a chopping device 22 in the form of a chopping drum, which chops this material into small pieces and transfers it to a conveying device 24. The material is discharged from the field chopper 10 and enters a trailer traveling close by or another transport vehicle via a rotatable discharge shaft 26. A regrinding device 28, which is constructed from two processor rolls arranged one above the other and through which the material to be conveyed is fed tangentially to the conveying device 24, is arranged between the chopping device 22 and the conveying device 24.

FIG. 2 shows a schematic representation of the feeding device 32. The lower feedrolls 34, 35 are rotatably mounted on a feed housing detachably mounted on the frame 12 of the field chopper 10 and are set in rotation in harvesting mode by means of a cutting-length gear (not shown, but see DE 102 07 467 A, whose disclosure is referenced in the present document). At rotational points 40, pivot elements 42 are rotatably mounted about axes extending parallel to the rotational axis of the feedrolls 34-37 on both sides of the pick-up housing 38. On its free ends 44, rockers 46 are also rotatably mounted about axes extending parallel to the rotational axis of the feedrolls 34-37. These each have a front bearing point 48 and a rear bearing point 50, in which shafts of the upper feedrolls 36, 37 are rotatably mounted. The shafts of the upper feedrolls 36, 37 can move upwards and downwards freely with the holder 46 in the region of slots 52, 54, which are located in the feed housing 38. The shafts of the upper feedrolls 36, 37 are also driven by the cutting-length gear in harvesting mode, in the opposite sense relative to the lower feedrolls 34, 35.

A first end 56 of a spring 58, which is constructed as a coil spring and whose second end 64 is attached to a holder 60, is fixed to the rocker 46. The holder 60 is hinged so that it can pivot on the feed housing 38 on its rear end about an axis 62 running parallel to the rotational axis of the feedrolls 34-37. The spring 58 extends downwards from the rocker 46 approximately vertically. Furthermore, a moving gate 66 of an adjustment drive 68 is hinged to the holder 60. The housing of this drive is hinged at a rotational point 70 on the feed housing 38, whose axis runs parallel to the rotational axis of the feedrolls 34-37 and is located above the holder 60, so that the adjustment drive 68 is located in front of the spring 58 in the forward direction of the field chopper 10 and extends approximately parallel to the spring. In other forms, the adjustment drive 68 could also be arranged behind the spring 58 or perpendicular to the forward direction of the field chopper 10 laterally next to the spring 58.

Springs 58 and adjustment drives 68 can be located on both sides of the feed housing 38. In another embodiment, a spring 58 and an adjustment drive 68 are located only on one side of the feed housing 38, with the rockers 46 being connected on both sides of the feed housing 38, one below the other by means of a transverse connection. Two springs 58 can also be used on both sides of the feed housing 38, whose second ends 64 are connected to each other and to a single adjustment drive 68 arranged on one side of the feed housing 38.

In the shown embodiment, the adjustment drive 68 is a double-acting hydraulic cylinder, whose chambers can be connected to a source 76 (here a pump, which could also be connected to an accumulator) under pressurized hydraulic fluid and to a tank 78 via a valve assembly 72. The valve assembly 72 can be activated electromagnetically by an electronic controller 74. The controller 74 is connected to a first sensor 76 in the form of a potentiometer, which is fixed to the axle 62 and which detects the actual rotational angle of the holder 60 about the axle 62. A second sensor 79 connected to the controller 74 in the form of a rotary or slide potentiometer connected to the rocker 46 in the direct vicinity of the first end 56 of the spring 58 detects the position of the rocker 46. A third crop throughput sensor 80 connected to the controller 74 in the form of a rotary or slide potentiometer connected to the rocker 46 in the direct vicinity of the shaft of the front feedroll 36 detects the position of the front feedroll 36.

According to the foregoing, the following function of the feeding device 32 is produced. The upper feedrolls 36, 37 are arranged to be movable relative to the lower feedrolls 34, 35 and are pre-tensioned downwards by the force of the spring 58 and pressed against the latter. The adjustment drive 68 enables a variation of the elongation and thus the force of the spring 58 by adjusting the position of the holder 60, which has the consequence of changing the contact pressure of the upper feedrolls 36, 37.

The controller 74 receives information on the relevant windrow height, which is proportional to the throughput, with reference to the output signal of the crop throughput sensor 80. In addition, the controller 74 receives information on the elongation of the spring 58, which, in turn, contains information concerning the applicable contact pressure of the feedrolls onto the crop, through difference formation with reference to the signals of the sensor 76, 79. When calculating the windrow height with reference to the signal of the crop throughput sensor 80, the controller 74 can also take into account the signals of the sensors 76, 79, in order to compensate the influence of the position of the adjustment drive 68 and the force of the spring 58 on the position of the front feedroll 36, wherein crop parameters (e.g., moisture and/or compressibility), which are input by the operator or detected by sensors (e.g., 76 and 79) and which influence the relationship between the quantity of incoming crop, the position of the feedroll 36, and the elongation of the spring 58, can also be taken into account. Instead of or in addition to the sensors 76, 79, a pressure sensor for detecting the pressure in the piston chamber of the adjustment drive 68 can also be provided. The controller 74 calculates the desired value for the contact pressure with reference to the windrow height (calculated by means of the signal of the crop throughput sensor 80). Here, arbitrary characteristic lines can be used, which can be stored in software as tables, curves, lists, or functional relationships.

An operator input device 84 can be provided, with which parameters of the characteristic line can be input by an operator for calculating the desired value of the contact pressure as a function of windrow height. Thus, the contact pressure for the minimum and maximum windrow height or the contact pressure for the minimum windrow height and the rise in contact pressure with windrow height can be input. This characteristic line could also be selected by the controller 74 as a function of the crop and its properties (e.g., the type of crop and moisture), which can be input by the operator or detected by means of suitable sensors. To prevent excessively high contact pressures, the maximum contact pressure can be limited in software. Another parameter for determining the characteristic line is the width of the feeding device 32, which can be programmed at the factory into the controller 74.

A linear rise in contact pressure with windrow height, with a relatively low slope and a sufficiently high contact pressure at lower windrow heights has proven to be advantageous. A constant contact pressure independent of windrow height would also be conceivable. The controller 74 then compares the calculated desired value of the contact pressure with the actual value measured with reference to the sensors 76, 70 and controls the valve assembly 72 and via this assembly the adjustment drive 68, such that the actual value is reached at least approximately.

To prevent damage to the feeding device 32 when feeding foreign bodies, the piston chamber of the adjustment device 68 is connected to a pressure-limiting valve 82, which bleeds the pressure into the tank 78 in such a case. Such a case is also recognized with reference to the crop throughput sensor 80 by the controller 74, which can then activate a blocking device, which is connected to a metal detector (in a known way, see DE 199 55 901 A and the state of the art cited there) and which can block the feeding device 32 for the purpose of preventing damage to downstream elements of the field chopper 10.

Having described the preferred embodiment, it will become apparent that various modifications can be made without departing from the scope of the invention as defined in the accompanying claims.

1. Feeding device (32) for a field chopper (10), comprising:
at least one rotatable lower feedroll (34, 35),
at least one rotatable upper feedroll (36, 37), between which a windrow can be led and fed to a chopping device (22),
and an external force-activated adjustment drive (68), with which the position of at least one of the feedrolls (36, 37) can be changed relative to the other feedroll (34, 35),
characterized in that a spring (58) is arranged between the adjustment drive (68) and the feedroll (36, 37) that can be moved by this drive.

2. Feeding device (32) according to claim 1, characterized in that the spring (58) pre-tensions the feedroll (36, 37) connected to the adjustment drive (68) against the other feedroll (34, 35).

3. Feeding device (32) according to claim 1 or 2, characterized in that the spring (58) is a tension spring.

4. Feeding device (32) according to one of claims 1 to 3, characterized in that a first end (56) of the spring (58) is connected to the feedroll (36, 37) and a second end of the spring (58) is connected to a pivoting and/or displaceable holder (60), which is further connected to the moving gate (66) of the adjustment drive (68).

5. Feeding device (32) according to one of claims 1 to 4, characterized in that the adjustment drive (68) and the spring (58) are arranged one next to the other.

6. Feeding device (32) according to one of claims 1 to 5, characterized in that the adjustment drive (68) and the spring (58) extend at least approximately vertically.

7. Feeding device (32) according to one of claims 1 to 6, characterized in that there are two feedrolls (36, 37), which are attached to a common rocker (46) and to which the downwardly extending spring (58) is connected.

8. Feeding device (32) according to one of the preceding claims, characterized by a controller (74), which is connected to the adjustment drive (68) and which can be operated to keep the contact pressure of the feedrolls (36, 37) onto the crop at least approximately independent of the crop throughput or to allow it to increase with increasing throughput.

9. Feeding device (32) according to claim 8, characterized in that the controller (74) is connected to a crop throughput sensor (80) designed for detecting the crop throughput and can be operated to drive the adjustment drive (68) as a function of an output of the crop throughput sensor (80), such that the contact pressure of the feedrolls (34-37) onto the crop remains at least approximately constant or increases with increasing throughput.

10. Feeding device (10) according to claim 9, characterized in that the crop throughput sensor (80) is designed for detecting the position of a moving feedroll (36).

11. Feeding device (10) according to one of claims 8 to 10, characterized in that the controller (74) is connected to a spring position sensor (76, 79), which is designed for detecting the elongation of the spring (58) and whose output can be used by the controller (74) as the actual value for the appropriate contact pressure of the feedrolls (34-37) onto the crop.

12. Feeding device (10) according to one of claims 8 to 11, characterized in that the controller (74) is connected to an operator input device (84) for the input of parameters of a characteristic line for calculating the desired value of the contact pressure of the feedrolls (34-37) as a function of windrow height and/or to a sensor (76, 79, 80) for detecting properties of the crop and whose signal is used for calculating parameters of a characteristic line for calculating the desired value of the contact pressure of the feedrolls (34-37) as a function of windrow height.

13. Field chopper (10) with a feeding device (32) according to one of claims 1 to 12.
